(19) United States
(12) Patent Application Publication
(10) Pub. No.: US 2007/0065197 A1
(43) Pub. Date: Mar. 22, 2007

(54) Automatic document feeder

(75) Inventor: Kouta Tanaka, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co. Ltd.

(21) Appl. No.: 11/352,397

(22) Filed: Feb. 13, 2006

(30) Foreign Application Priority Data
Sep. 21, 2005 (JP) P2005-274215

(51) Int. Cl. G03G 15/00

(52) U.S. Cl. 399/374

(57) ABSTRACT

An automatic document feeder includes a feeding unit that feeds an original sheet set at a predetermined position; and a conveying unit that conveys the original sheet fed by the feeding unit to a first reading position of a first reading unit that reads one face of the original sheet. The automatic document feeder is capable of being equipped with one of a reverse-conveying unit that reverses face of the original sheet and conveys the reversed original sheet to the conveying unit and a second reading unit that reads another face of the original sheet.

### BACKGROUND OF THE INVENTION

1. Field of the Invention

The present invention relates to an automatic document feeder which is employed in an image forming apparatus such as a copying machine and a facsimile employing electrophotographic system, or an image input terminal such as a scanner, and more particularly, relates to the automatic document feeder by which images on both faces of the original sheet can be read.

2. Description of the Related Art

Conventionally, the automatic document feeder of this type is constructed in such a manner that a plurality of original sheets placed on an original sheet tray can be automatically conveyed to an image reading position in a state separated one by one, and discharged to a discharging tray, after an image on the original sheet has been read by image reading unit which is arranged at the image reading position. This automatic document feeder is adapted to read the image on one face of the original sheet, by automatically conveying the original sheet to the image reading position.

By the way, in recent years, variety of documents to be dealt in an office or so has been more and more increased, and not only the image printed on the one face of the document but also the images printed on both faces of the document have become frequently read to be copied or transmitted by facsimile.

For this reason, besides the automatic document feeder of the type capable of reading the image only on the one face, various types of the automatic document feeders capable of reading the images on both the faces have been also proposed, and actually developed into products.

However, in case of the automatic document feeder capable of reading the images on both the faces, it is necessary to provide second image reading unit for reading the image on a back face of the original sheet, which incurs an increase of cost. Therefore, customers who rarely read the images on both the faces of the original sheet do not need, in many cases, the automatic document feeder capable of reading the images on both the faces.

As described above, the conventional automatic document feeders have been completely separated into two types, the one exclusively for reading the one face, and the other exclusively for reading both the faces. Therefore, in case where the customer who had initially used the device for exclusively reading the one face, has more and more become in necessity of reading both the faces of the original sheet, he has to newly introduce the automatic document feeder exclusively for reading both the faces. Accordingly, there has been such a problem that it is impossible to make effective use of the device exclusively for reading the one face which he had used until then.

Under the circumstances, as related art for solving the above described problem, there have been already proposed, image input terminals having such a structure that second reading unit can be detachably provided, whereby it is possible to select either the image input terminal exclusively for one face or the image input terminal for both the faces in which the images on both the faces of the original sheet can be read in one pass by primary reading unit and by the second reading unit.

Related art discloses the both-face original sheet reading device which is an original sheet reading device including automatic original sheet feeding unit mounted on a scanner part of a main body and provided with a pressure plate covering a contact glass face of the scanner part, whereby an image is read by a first optical reading unit inside the scanner part, while an original sheet is fed and moved along a reading part on the scanner part by the automatic original sheet feeding unit, characterized in that a paper discharging outlet of the automatic original sheet feeding unit is provided at a side of the pressure plate covering the contact glass face of the scanner part, and an original sheet conveying and reading part is detachably arranged on the pressure plate, the original sheet conveying and reading part including a second optical reading unit for reading an image on an opposite face of the original sheet, and original sheet conveying unit for receiving the original sheet which has been discharged from the paper discharging outlet of the automatic original sheet feeding unit and for conveying the original sheet to the second optical reading unit.

Related art discloses an image input terminal including first reading unit provided with a first reading part for reading one face of an original sheet, an original sheet conveying path in which the first reading part is positioned, and a plurality of conveying unit for conveying the original sheet along the original sheet conveying path, characterized in that a part of a conveyance guide body which is disposed on the conveying path at an opposite side to the first reading part can be sidetracked from the conveying path, and an opening is formed so that second reading unit for reading an opposite face to the face to be read by the first reading unit, when a part of the conveyance guide body has been sidetracked, can be mounted.

Further, related art discloses an image input terminal incorporating first optical reading unit, and including a first image reading part for reading an image on a first face of an original sheet, which is placed on a platen, by the first optical reading unit, conveying unit connected to the first image reading part for conveying the original sheet to the platen, a second reading part positioned at an opposite side to the first optical reading unit across the platen, and incorporating second optical reading unit for reading a second face of the original sheet, and at least one cover which can be opened or closed, among outer packages covering an outer frame of the second image reading part, characterized in that the second optical reading unit can be attached or detached by opening a part of the outer package.

However, the above described related art has the following problems. Specifically, the image input terminals disclosed in the aforesaid related art are constructed in such a manner that the second reading unit can be detachably provided, whereby it is possible to select either the image input terminal exclusively for one face, or the image input terminal for both the faces in which the images on both the faces of the original sheet can be read in one pass, by the two reading unit. However, considering recent circumstances of the market where both-faced original sheets have more and more increased in number, there has been a problem that the image input terminal exclusively for the one face which is low-cost but unable to read both the faces cannot comply with needs of those customers who want to read both the faces, and on the other hand, the image input terminal capable of reading both the faces in one pass requires a remarkable increase of the cost, and so, cannot comply with needs of those customers who need to read both the faces but cannot bear the remarkable increase of the cost.

Under the circumstances, in order to comply with the needs of the customers as described above, it is necessary to provide an automatic document feeder which can realize selectively, a function capable of reading the images on both the faces of the original sheet by reversing front and back faces of the original sheet, while an increase of the cost is restrained to the least, for the customers who prefer cost performance, and a function capable of reading the images on both the faces of the original sheet in one pass for the customers who prefer high productivity.

In case of the automatic document feeder which can selectively realize the above described two functions, it would be more preferable that components may be commonly used for the two functions, for the purpose of reading production cost. Particularly, in case where the automatic document feeder is attached to the image input terminal so as to be opened or closed, serving also as a platen cover for setting the original sheet on the image input terminal, it would be desirable that a hinge for attaching the automatic document feeder may be commonly used for the two functions, because the hinge for attaching the automatic document feeder so as to be opened or closed is basically one of the most expensive components among these components constituting the automatic document feeder.

However, types and arrangements of the components are completely different, between the automatic document feeder capable of reading the images on both the faces of the original sheet by reversing the front and back faces of the original sheet, and the automatic document feeder capable of reading the images on both the faces of the original sheet in one pass, and accordingly, weights of the automatic document feeders, and positions of their centers of gravity are different from each other. For this reason, it has been necessary to use the hinges of different types for attaching the automatic document feeder to the image input terminal so as to be opened or closed, and there has been another problem that the production cost cannot be reduced in this respect.

### SUMMARY OF THE INVENTION

The present invention has been made in view of above circumstances and provides an automatic document feeder.

According to an aspect of the invention, there is provided an automatic document feeder including: a feeding unit that feeds an original sheet set at a predetermined position; and a conveying unit that conveys the original sheet fed by the feeding unit to a first reading position of a first reading unit that reads one face of the original sheet. The automatic document feeder is capable of being equipped with one of a reverse-conveying unit that reverses face of the original sheet and conveys the reversed original sheet to the conveying unit and a second reading unit that reads another face of the original sheet.

### BRIEF DESCRIPTION OF THE DRAWINGS

Embodiments of the present invention will be described in detail based on the following figures, wherein:

FIG. 1 is a structural view showing an automatic document feeder according to Embodiment 1 of the invention;

FIG. 2 is a structural view showing an image forming apparatus to which the automatic document feeder according to Embodiment 1 of the invention has been applied;

FIG. 3 is a structural view showing the automatic document feeder according to Embodiment 1 of the invention;

FIG. 4 is a structural view showing the automatic document feeder according to Embodiment 1 of the invention;

FIG. 5 is a structural view showing the automatic document feeder according to Embodiment 1 of the invention.

### DETAILED DESCRIPTION OF THE INVENTION

Embodiments of the invention will be described referring to the drawings.

### Embodiment 1

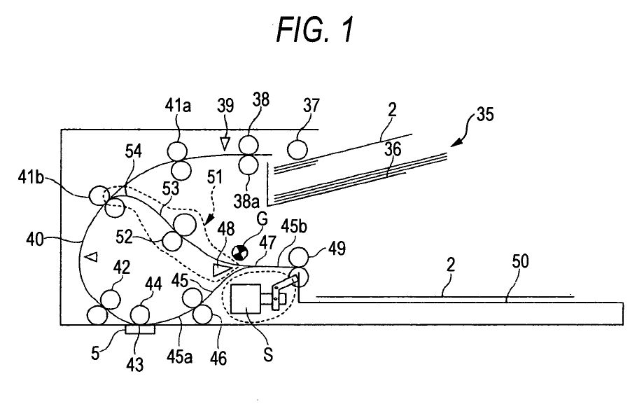

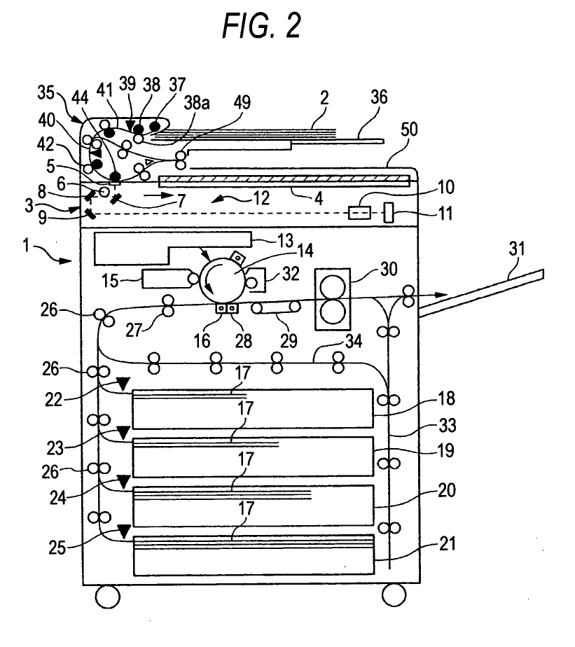

FIG. 1 shows an automatic document feeder in Embodiment 1 according to the invention, and FIG. 2 shows a digital copying machine on which the automatic document feeder in Embodiment 1 of the invention is mounted.

In FIG. 2, numeral 1 represents a main body of the digital copying machine. An image input terminal (hereinafter referred to as “IIT”) 3 for reading images of an original sheet 2 is arranged in an upper end part of this digital copying machine body 1. The IIT 3 includes a first platen glass 4 on which the original sheet 2 is placed at a predetermined position for reading the image of the original sheet 2, and a second platen glass 5 in a shape of slit which is disposed at one end of the first platen glass 4 for reading the image while conveying the original sheet 2 is conveyed at a constant speed. The ITT 3 is further provided with an exposing optical system 12. The exposing optical system 12 includes an illuminating lamp 6 which illuminates the original sheet 2 in order to read the image of the original sheet 2 placed on the first platen glass 4, or the original sheet 2 which moves along a surface of the second platen glass 5 at a constant speed, a full rate mirror 7 for reflecting a reflected optical image of the original sheet 2 which is illuminated by the illuminating lamp 6, two half rate mirrors 8, 9 for reflecting the optical image from the full rate mirror 7 so as to return, an image forming lens 10 which forms the optical image of the original sheet 2 which has been reflected by these half rate mirrors 8, 9, in a reduced state, on an image reading element, and an image sensor 11 such as CCD or the like for reading the image of the original sheet 2 which has been formed by the image forming lens 10. Among components constituting the exposing optical system 12, the illuminating lamp 6 and the full rate mirror 7 are attached to a first carriage, which is not shown, and the two half rate mirrors 8, 9 are attached to a second carriage, which is not shown. The first carriage carrying the illuminating lamp 6 and the full rate mirror 7, and the second carriage carrying the two half rate mirrors 8, 9 are moved in a direction of an arrow mark at a speed ratio of 1:1/2 according to the image exposing system, or stopped at a position as shown in FIG. 2, thereby to expose the image of the original sheet 2 to light.

In order to read the image of the original sheet 2 which moves along the surface of the second platen glass 5 by the IIT 3, the image sensor 11 is adapted to read the image of the original sheet 2, in a state where an entirety of the exposing optical system 12 is stopped at the predetermined position so that the full rate mirror 7 may come into an image reading position directly below the second platen glass 5, as shown in FIG. 2. Moreover, in order to read the image of the original sheet 2 placed on the first platen glass 4 by the IIT 3, the image sensor 11 is adapted to read the image of the original sheet 2, while the illuminating lamp 6, the full rate mirror 7, and the half rate mirrors 8, 9 move at a speed ratio of 1:1/2 along a lower face of the original sheet 2.

In the digital copying machine, in case where the image of the original sheet 2 is read by original sheet moving type exposing method, information of the image on the original sheet 2 which is conveyed to the image reading position at a constant speed by unit of an automatic document feeder 35, which is described below, is read by the IIT 3, as shown in FIG. 2. The information of the image on the original sheet 2 which has been read by the IIT 3 is copied on a copying sheet by an image output terminal (hereinafter referred to as IOT) which is arranged inside the digital copying machine body 1. Specifically, the information of the image on the original sheet 2 which has been read by the IIT 3 is stored in a temporary memory, which is not shown, and is subjected to predetermined image treatment, according to necessity. Thereafter, according to the information which has been subjected to the image treatment, the image is exposed on a photoconductive drum 14 by a ROS (Raster Output Scanner) 13 thereby to form an electrostatic latent image. This electrostatic latent image formed on the photoconductive drum 14 is developed by a developing unit 15 to form a toner image. This toner image is transferred onto the copying sheet 17 by unit of a transferring electrifier 16. The copying sheets 17 respectively having predetermined sizes are fed from a plurality of paper trays 18, 19, 20, 21 which are contained in a lower part of the digital copying machine body 1, and are detected by feed sensors 22, 23, 24, 25. Thereafter, the copying sheets 17 are conveyed to register rolls 27 upstream of the photoconductive drum 14 by a plurality of conveying rolls 26. Then, the copying sheet 17 is conveyed by the register rolls 27 to a surface of the photoconductive drum 14 synchronously with the toner image which has been formed on the photoconductive drum 14.

The copying sheet 17 having the toner image which has been transferred from the photoconductive drum 14 is separated from the photoconductive drum 14 by a separating electrifier 28, and then, conveyed to a fixing unit 30 by unit of a conveying belt 29. In the fixing unit 30, the toner image is fixed on the copying sheet 17 with heat and pressure, and the copying sheet 17 is discharged to a discharging tray 31 which is arranged outside the device. In this manner, copying process of the image is completed.

The toner or paper dust remained on the surface of the photoconductive drum 14 after the transferring process of the toner image has been finished is removed by a cleaning unit 32, and prepared for the next copying process.

In case where both the faces of the original sheet are copied by the digital copying machine, the copying sheet 17 which has the copied image on its one face is not directly discharged to the discharging tray 31, but conveyed to a sheet reversing path 33 by switching a conveying path, and then, is conveyed again to the image forming part below the photoconductive drum 14 by way of a sheet conveying path 34 for both faces, in a state where the front and back faces of the copying sheet 17 are reversed. In this manner, the image is copied on the back face of the copying sheet 17, and thereafter, the copying sheet 17 is discharged onto the discharging tray 31.

By the way, as shown in FIG. 1, the automatic document feeder 35 mounted on the digital copying machine is provided with an original sheet setting tray 36 on which a plurality of the original sheets 2 to be copied are set with their copying faces (front faces) directed upward (so-called “face up”). A plurality of the copying sheets 2 which have been set on the original sheet setting tray 36 is picked up by a pickup roll 37 from top of the sheet, in order from No. 1 to N, and conveyed to a feed roll 38 and a retard roll 38a. Moreover, an original sheet feed sensor 39 for detecting a state of feeding the original sheet 2 is arranged at a backward end of the feed roll 38. Another original sheet detecting sensor represented by a small triangular mark is also arranged at a predetermined position. The original sheets 2 are separated one by one by these feed roll 38 and retard roll 38a, and conveyed to pre-registration rolls 42 along an upstream conveying path 40 which is formed in a circular shape, by way of takeaway rolls 41a, 41b provided on the way, to temporarily stop at the pre-registration rolls 42. Thereafter, the original sheet 2 is conveyed at a predetermined timing by the pre-registration rolls 42 to the image reading position 43 on the second platen glass 5 at a constant speed. The image of the original sheet 2 which has been conveyed to the image reading position 43 on the second platen glass 5 at a constant speed is read by the image sensor 11 including the CCD or the like, by way of the exposing optical system 12 of the image input terminal (IIT) 3 which is the first reading unit stopped at the position as shown in FIG. 2, while it is conveyed at a constant speed by auxiliary conveying action of a platen roll 44 which is arranged above the second platen glass 5.

After the image has been read at the image reading position 43 on the second platen glass 5, the original sheet 2 is conveyed along a forward end 45a of a downstream conveying path 45 which is formed in a circular shape, as shown in FIG. 1, by the platen roll 44 and out rolls 46. Then, the original sheet 2 is discharged by discharging rolls 49 which are arranged at a backward end 45b of the downstream conveying path 45 onto the original sheet discharging tray 50 provided below the original sheet setting tray 36, as shown in FIG. 1, by way of a first branching part 47 provided with a reversing gate 48. The above mentioned discharging rolls 49 are so designed that a nip between them can be released by a solenoid S at a predetermined timing.

By the way, in this embodiment, there is provided the automatic document feeder comprising the feeding unit for feeding a plurality of original sheets which have been set at a predetermined position, sequentially one by one, and the original sheet conveying unit for conveying each of the original sheets which has been fed by the feeding unit to the reading position of the first reading unit, characterized in that either original sheet reverse-conveying unit for conveying again the original sheet, after an image on its one face has been read by the first reading unit, to the original sheet conveying unit in a state where front and back faces of the original sheet have been reversed, or second reading unit for reading the other face of the original sheet conveyed by the original sheet conveying unit, opposite to the face which has been read by the first reading unit can be selectively mounted on the automatic document feeder.

It is to be noted that the original sheet reverse-conveying unit and the second reading unit may be selectively mounted on the automatic document feeder, for example, when it is assembled.

Moreover, in this embodiment, the automatic document feeder is so constructed that the original sheet reverse-conveying unit and the second reading unit have substantially the same weight.

Further, in this embodiment, the automatic document feeder is so constructed that the center of gravity of the automatic document feeder lies substantially at the same position, both in case where the original sheet reverse-conveying unit has been mounted, and in case where the second reading unit has been mounted.

FIG. 1 shows the automatic document feeder according to the embodiment, in a state provided with the original sheet reverse-conveying unit.

As described above, this automatic document feeder 35 is constructed in such a manner that in order to read the one face (front face) of the original sheet, the original sheets 2 set on the original sheet setting tray 36 are fed in a state separated one by one, and the image on the one face (front face) of the original sheet 2 is read at the image reading position 43 on the second platen glass 5, while the original sheet 2 is conveyed along the upstream conveying path 40 and the downstream conveying path 45.

The original sheet 2 which has been read at the image reading position 43 is conveyed to the discharging rolls 49 along the downstream conveying path 45, and sequentially discharged onto the original sheet discharging tray 50 by the discharging rolls 49, with their front face directed downward.

In this case too, some customers request to avoid an increase of the cost, although they would like both faces of the original sheet 2 to be read by unit of the automatic document feeder 35, while some other customers would like both the faces of the original sheet 2 to be read rapidly to enhance productivity, although an increase of the cost is acceptable.

Under the circumstances, in this embodiment, the original sheet reverse-conveying unit 51 (a group of components encircled by a dotted line in FIG. 1) is selectively mounted on the automatic document feeder 35, as shown in FIG. 1, for those customers who request to avoid an increase of the cost, although they would like both the faces of the original sheet 2 to be read by the automatic document feeder 35.

The original sheet reverse-conveying unit 51 to be mounted on the automatic document feeder 35 includes, as shown in FIG. 1, the branching part 47 for branching the downstream conveying path 45 on the way, the reversing gate 48 provided in the branching part 47, a front and back reverse-conveying path 53 provided with conveying rolls 52 for reversing the front and back faces of the original sheet 2 which has been branched in the branching part 47 and conveying it again to the upstream conveying path 40, a merging part 54 for merging the front and back reverse-conveying path 53 to the upstream conveying path 40, the solenoid S for releasing the nip of the discharging rolls 49, and drive unit, which is not shown, for driving the reversing gate 48 and the conveying rolls 52. The drive unit may, of course, include an independent drive source such as a drive motor or the like, but may also include unit for transmitting a driving force to the conveying rolls 52 and so on, from a drive source originally provided on the automatic document feeder 35 through belts, pulleys, gears or the like.

In case where both the faces of the original sheet 2 are read and copied with this automatic document feeder 35, the original sheet 2 after the image on its one face has been read is not directly discharged onto the original sheet discharging tray 50 by the discharging rolls 49. On the other hand, as shown in FIG. 1, the conveying path is switched to the front and back reverse-conveying path 53 by unit of the reversing gate 48, and at the same time, the discharging rolls 49 are reversed while a backward end of the original sheet 2 is clamped by the discharging rolls 49, thereby to convey the original sheet 2 to the front and back reverse-conveying path 53 in a state where the front and back faces have been reversed and its backward end has been converted into a forward end. Then, the original sheet 2 is conveyed to the upstream conveying path 40 through the merging part 54, by unit of the conveying rolls 52 provided in the front and back reverse-conveying path 53. On this occasion, the discharging rolls 49 are released from nipped state by unit of the solenoid S at a predetermined timing.

Then, the original sheet 2 is conveyed to the upstream conveying path 40 in a state where an opposite face (back face) to the face already read is directed downward, and the opposite face (back face) of the original sheet 2 is read at the image reading position 43 on the second platen glass 5.

After the image on the back face has been read, the original sheet 2 is conveyed again to the discharging rolls 49, but is not discharged by the discharging rolls 49 directly onto the original sheet discharging tray 50. The above described process of passing the original sheet through the front and back reverse-conveying path 53 is repeated, and the front and back faces of the original sheet 2 is reversed again. In this state, that is, in a state where the front face is directed downward, the original sheet 2 is discharged onto the original sheet discharging tray 50 by unit of the discharging rolls 49.

On this occasion, the nipped state of the original sheet 2 between the discharging rolls 49 is turned ON or OFF by the solenoid S at the predetermined timing. This is because when the front and back faces of the original sheet 2 are reversed, the original sheet 2 cannot be smoothly conveyed, depending on sizes of the original sheet 2, in a state where the original sheet 2 is nipped by the discharging rolls 49 together with all the rolls provided in the front and back reverse-conveying path 53, the upstream conveying path 40, and the downstream conveying path 45, since travel lengths of the front and back reverse-conveying path 53, the upstream conveying path 40, and the downstream conveying path 45 are short.

In this embodiment, when a group of the components constituting the original sheet reverse-conveying unit 51 are mounted on the automatic document feeder 35, it is of course possible to mount the components individually, as shown in FIG. 1, but in this case, it is concerned that mounting work would be complicated.

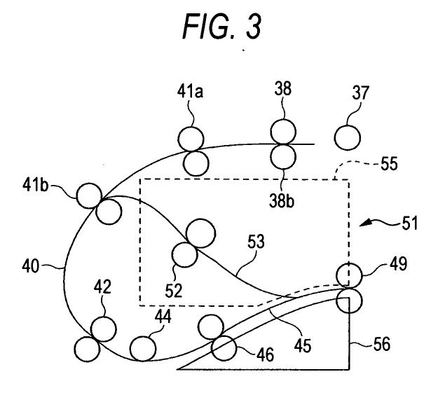

On occasion of mounting the group of components constituting the original sheet reverse-conveying unit 51 on the automatic document feeder 35, the group of the components constituting the original sheet reverse-conveying unit 51 may be formed into two exchangeable units 55 and 56, as shown in FIG. 3. The first exchangeable unit 55 includes the branching part 47, the reversing gate 48 provided in the branching part 47, the front and back reverse-conveying path 53 provided with the conveying rolls 52 for reversing the front and back faces of the original sheet 2 which has been branched in the branching part 47 and conveying it again to the upstream conveying path 40, the merging part 54 for merging the front and back reverse-conveying path 53 to the upstream conveying path 40, and the drive unit, which is not shown, for driving the reversing gate 48 and the conveying rolls 52. The second exchangeable unit 56 includes the solenoid S for releasing the nip of the discharging rolls 49. Then, the group of the components constituting the original sheet reverse-conveying unit 51 which are unitized into the first exchangeable unit 55 and the second exchangeable unit 56 may be mounted on the automatic document feeder 35, as shown in FIG. 3.

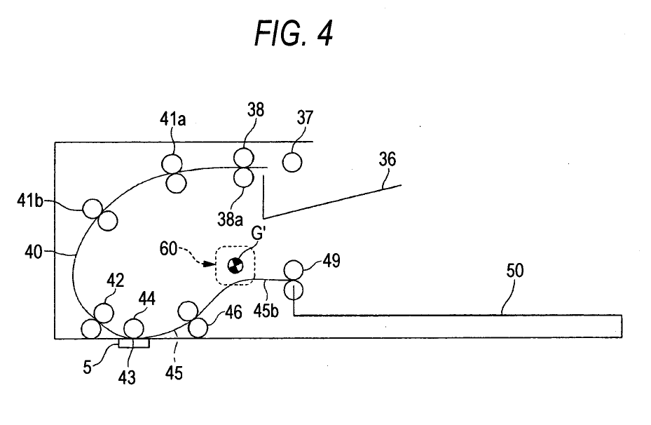

Moreover, in this embodiment, for those customers who would like both the faces of the original sheet 2 to be read by the automatic document feeder 35 rapidly to enhance productivity, even though the cost is increased, the automatic document feeder 35 is constructed in such a manner that second reading unit 60 for reading the other face of the original sheet conveyed by the original sheet conveying unit, opposite to the face read by the first reading unit may be selectively mounted, as shown in FIG. 4.

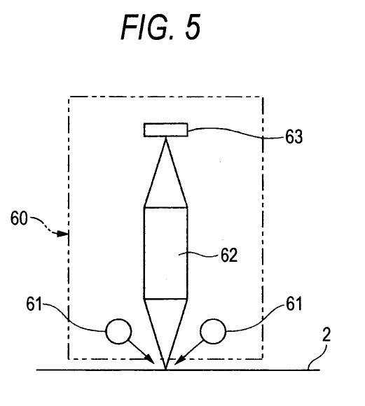

As shown, for example, in FIG. 4, the second reading unit 60 to be mounted on the automatic document feeder 35 is arranged at a backward end 45b of the downstream conveying path 45, that is, at a position upstream of the discharging roll 49 in the downstream conveying path 45. However, the position of the second reading unit 60 is not limited to the above described position, but the second reading unit 60 may be, of course, provided at other positions. The second reading unit 60 is, for example, as shown in FIG. 5, a contact type image reading sensor or the like, which includes a light source 61 such as an LED for illustrating the back face of the original sheet 2, a SELFOC lens (trade name) 62 which gathers reflected lights from the original sheet 2 to form an image of an equal size, and an image reading element 63 such as a CCD which reads the image of the equal size formed by the SELFOC lens (trade name) 62.

As shown in FIG. 4, the above described second reading unit 60 is so constructed that the image on the back face of the original sheet 2 can be read by the image reading element 63, after the image on the front face has been read at the image reading position 43 on the second platen glass 5, by illuminating the image on the back face with the light source 61 and forming the image on the image reading element 63 with the SELFOC lens (trade name) 62, while the original sheet 2 is conveyed to the discharging rolls 49 along the downstream conveying path 45.

After the image on the back face has been read by the second reading unit 60, the original sheet 2 is discharged in this state onto the original sheet discharging tray 50. In this manner, the images on both the faces of the original sheet 2 can be read rapidly, and the automatic document feeder 35 having high productivity can be obtained.

Moreover, in this embodiment, the original sheet reverse-conveying unit 51 having the structure as shown in FIG. 1 and the second reading unit 60 having the structure as shown in FIG. 4 are so constructed that they have substantially the same weight. For this purpose, the total weight of the members constituting the original sheet reverse-conveying unit 51, and the total weight of the members constituting the second reading unit 60 are set to be substantially equal to each other. However, in case where the weights of both the unit are not substantially equal to each other, either the original sheet reverse-conveying unit 51 or the second reading unit 60 may be provided with a weight for equalizing their weights, for example, in order to eliminate a difference in weight between them.

Further, in this embodiment, the original sheet reverse-conveying unit 51 having the structure as shown in FIG. 1 and the second reading unit 60 having the structure as shown in FIG. 4 are so constructed that their centers of gravity are substantially at the same position. Because the center of gravity G of the original sheet reverse-conveying unit 51 is positioned nearly above the reversing gate 48, as shown in FIG. 1, and the center of gravity G′ of the second reading unit 60 is apparently positioned inside it, both the centers of gravity G, G′ are substantially at the same position. In case where the original sheet reverse-conveying unit 51 is lighter in weight, it is possible to coincide the positions of the centers of gravity G, G′, by adjusting a position of the weight to be mounted on the original sheet reverse-conveying unit 51.

In the automatic document feeder according to Embodiment 1 having the above described structure, it is possible to comply with the two needs, namely the need for the automatic document feeder capable of reading both the faces while an increase of the cost is restrained, and the need for the automatic document feeder capable of reading both the faces while high productivity is preferred to cost, and it is also possible to commonly use the components such as the hinge for opening or closing, in the following manner.

Specifically, the automatic document feeder 35 according to Embodiment 1 is constructed in such a manner that the original sheet reverse-conveying unit may be selectively mounted on the automatic document feeder 35, as shown in FIG. 1, for those customers who request to avoid an increase of the cost, although they would like both the faces of the original sheet 2 to be read by unit of the automatic document feeder 35.

The original sheet reverse-conveying unit 51 includes, as shown in FIG. 1, the branching part 47 for branching the downstream conveying path 45 on the way, the reversing gate 48 provided in the branching part 47, the front and back reverse-conveying path 53 provided with the conveying rolls 52 for reversing the front and back faces of the original sheet which has been branched in the branching part 47 and conveying it again to the upstream conveying path 40, the merging part 54 for merging the front and back reverse-conveying path 53 to the upstream conveying path 40, the solenoid S for releasing the nip of the discharging roll 49, and the drive unit, which is not shown, for driving the reversing gate 48 and the conveying rolls 52.

For this reason, the original sheet reverse-conveying unit can be manufactured at a low cost, because it includes only mechanical components of low cost, and therefore, it is possible to restrain an increase of the cost, even in case where the original sheet reverse-conveying unit has been mounted on the automatic original sheet conveying unit 35.

However, the above described original sheet reverse-conveying unit 51 is constructed in such a manner that the original sheet 2 after the image on the front face has been already read can be conveyed again to the image reading position 43 by way of the front and back reverse-conveying path 53 in a state where the front and back faces of the original sheet 2 have been reversed, and the back face of the original sheet 2 can be read at the image reading position 43. Therefore, it will take a considerable time to read the images on both the faces of the original sheet 2.

Moreover, in this embodiment, for those customers who would like both the faces of the original sheet 2 to be read by the automatic document feeder 35 rapidly to enhance productivity, even though the cost is increased, the automatic document feeder 35 may be selectively provided, as shown in FIG. 4, with the second reading unit 60 which reads the other face of the original sheet 2 conveyed by the original sheet conveying unit including the upstream conveying path 40, the downstream conveying path 45 and the rolls arranged in the conveying path as, opposite to the face read by the first reading unit.

For this purpose, the automatic document feeder 35 is so constructed, as shown in FIG. 4, that the second reading unit 60 arranged in the downstream conveying path 45 may read the image on the back face of the original sheet 2, after the image on its front face has been read at the image reading position 43, while the original sheet 2 is discharged onto the original sheet discharging tray 50 by the discharging rolls 49 by way of the downstream conveying path 45. Therefore, it is possible to rapidly read the images on both the front and back faces of the original sheet 2, and the productivity is enhanced.

However, the production cost of the second reading unit is high, because it includes particular optical components such as the SELFOC lens (trade name) 62, and electronic components such as the CCD as the image reading element 63. Therefore, the cost for the automatic document feeder 35 is remarkably increased.

Moreover, in this embodiment, the weights of the original sheet reverse-conveying unit 51 and the second reading unit 60 are set to be substantially equal to each other. At the same time, the centers of gravity G, G′ of the original sheet reverse-conveying unit 51 and the second reading unit 60 are set to be substantially at the same position. For this reason, in the automatic document feeder 35 selectively provided with the original sheet reverse-conveying unit 51, and in the automatic document feeder 35 selectively provided with the second reading unit 60, their weights and the positions of their centers of gravity are substantially the same. As the hinge for mounting the automatic document feeder 35 which is selectively provided with either the original sheet reverse-conveying unit or the second reading unit so as to be opened or closed, the same hinge as employed in the automatic document feeder 35 exclusively for the one face can be used. Therefore, it is possible to commonly use the components such as the hinge for mounting the device so as to be opened or closed.

In this manner, in the automatic document feeder 35 according to Embodiment 1, it may be possible to comply with the two needs, namely, the need for the automatic document feeder capable of reading both the faces while an increase of the cost is restrained, and the need for the automatic document feeder capable of reading both the faces while high productivity is preferred to cost performance. It also may be possible to commonly use the components such as the hinge for mounting the device so as to be opened or closed.

The entire disclosure of Japanese Patent Application No. 2005-274215 filed on Sep. 21, 2005 including specification, claims, drawings and abstract is incorporated herein be reference in its entirety.

What is claimed is:

1. An automatic document feeder comprising:
a feeding unit that feeds an original sheet set at a predetermined position; and
a conveying unit that conveys the original sheet fed by the feeding unit to a first reading position of a first reading unit that reads one face of the original sheet;
wherein the automatic document feeder is capable of being equipped with one of a reverse-conveying unit that reverses face of the original sheet and conveys the reversed original sheet to the conveying unit and a second reading unit that reads another face of the original sheet.

2. The automatic document feeder according to claim 1,
wherein the reverse-conveying unit and the second reading unit have substantially same weight.

3. The automatic sheet feeder according to claim 1,
wherein a center of gravity of the automatic document feeder lies substantially at the same position both in case that the reverse-conveying unit is equipped and in case that the second reading unit is equipped.
